(19) United States
(12) Patent Application Publication
(10) Pub. No.: US 2005/0246164 A1
(43) Pub. Date: Nov. 3, 2005

(54) Coding of audio signals

(75) Inventors: Pasi Ojala, Kauniainen (FI); Jari Makinen, Tampere (FI); Ari Lakaniemi, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/107,334

(22) Filed: Apr. 15, 2005

(30) Foreign Application Priority Data
Apr. 15, 2004 (FI) FI20045135

(51) Int. Cl. G10L 19/14

(52) U.S. Cl. 704/205

(57) ABSTRACT

An encoder comprises an input for inputting frames of an audio signal in a frequency band, an analysis filter dividing the frequency band into lower and higher frequency bands, a first encoding block for encoding the audio signals of the lower frequency band, a second encoding block for encoding the audio signals of the higher frequency band, and a mode selector for selecting an operating mode for the encoder among at least a first mode where signals only on the lower frequency band are encoded, and a second mode where signals on both the lower and higher frequency band are encoded. The encoder has a scaler to gradually change the encoding properties of the second encoding block in connection with a change in the operating mode of the encoder. The invention also relates to a device, a decoder, a method, a module, a computer program product, and a signal.

### CROSS-REFERENCE TO RELATED APPLICATIONS

This application claims priority under 35 USC §119 to Finnish Patent Application No. 20045135 filed on Apr. 15, 2004.

### FIELD OF THE INVENTION

The present invention relates to an encoder comprising an input for inputting frames of an audio signal in a frequency band, an analysis filter for dividing the frequency band into at least a lower frequency band and a higher frequency band, a first encoding block for encoding the audio signals of the lower frequency band, a second encoding block for encoding the audio signals of the higher frequency band, and a mode selector for selecting an operating mode for the encoder among at least a first mode and a second mode, in which first mode signals only on the lower frequency band are encoded, and in which second mode signals on both the lower and higher frequency band are encoded. The invention also relates to a device comprising an encoder comprising an input for inputting frames of an audio signal in a frequency band, an analysis filter for dividing the frequency band into at least a lower frequency band and a higher frequency band, a first encoding block for encoding the audio signals of the lower frequency band, a second encoding block for encoding the audio signals of the higher frequency band, and a mode selector for selecting an operating mode for the encoder among at least a first mode and a second mode, in which first mode signals only on the lower frequency band are encoded, and in which second mode signals on both the lower and higher frequency band are encoded. The invention also relates to a system comprising an encoder comprising an input for inputting frames of an audio signal in a frequency band, at least a first excitation block for performing a first excitation for a speech like audio signal, and a second excitation block for performing a second excitation for a non-speech like audio signal. The invention further relates to a method for compressing audio signals in a frequency band, the frequency band is divided into at least a lower frequency band and a higher frequency band, the audio signals of the lower frequency band are encoded by a first encoding block, the audio signals of the higher frequency band are encoded by a second encoding block, and a mode is selected for the encoding among at least a first mode and a second mode, in which first mode signals only on the lower frequency band are encoded, and in which second mode signals on both the lower and higher frequency band are encoded. The invention relates to a module for encoding frames of an audio signal in a frequency band which is divided into at least a lower frequency band and a higher frequency band, the module comprising a first encoding block for encoding the audio signals of the lower frequency band, a second encoding block for encoding the audio signals of the higher frequency band, and a mode selector for selecting an operating mode for the module among at least a first mode and a second mode, in which first mode signals only on the lower frequency band are encoded, and in which second mode signals on both the lower and higher frequency band are encoded. The invention relates to a computer program product comprising machine executable steps for compressing audio signals in a frequency band divided into at least a lower frequency band and a higher frequency band, for encoding the audio signals of the lower frequency band by a first encoding block, for encoding the audio signals of the higher frequency band by a second encoding block, and for selecting a mode for the encoding among at least a first mode and a second mode, in which first mode signals only on the lower frequency band are encoded, and in which second mode signals on both the lower and higher frequency band are encoded. The invention relates to a signal comprising a bit stream including parameters for a decoder to decode the bit stream, the bit stream being encoded from frames of an audio signal in a frequency band, which is divided into at least a lower frequency band and a higher frequency band, and at least a first mode and a second mode are defined for the signal, in which first mode signals only on the lower frequency band are encoded, and in which second mode signals on both the lower and higher frequency band are encoded.

### BACKGROUND OF THE INVENTION

In many audio signal processing applications audio signals are compressed to reduce the processing power requirements when processing the audio signal. For example, in digital communication systems audio signal is typically captured as an analogue signal, digitised in an analogue to digital (A/D) converter and then encoded before transmission over a wireless air interface between a user equipment, such as a mobile station, and a base station. The purpose of the encoding is to compress the digitised signal and transmit it over the air interface with the minimum amount of data whilst maintaining an acceptable signal quality level. This is particularly important as radio channel capacity over the wireless air interface is limited in a cellular communication network. There are also applications in which a digitised audio signal is stored to a storage medium for later reproduction of the audio signal.

The compression can be lossy or lossless. In lossy compression some information is lost during the compression wherein it is not possible to fully reconstruct the original signal from the compressed signal. In lossless compression no information is normally lost. Hence, the original signal can usually be completely reconstructed from the compressed signal.

In telephony services speech is often bandlimited to between approximately 200 Hz and 3400 Hz. The typical sampling rate used by an A/D converter to convert an analogue speech signal into a digital signal is either 8 kHz or 16 kHz. Music or non-speech signals may contain frequency components well above the normal speech bandwidth. In some applications the audio system should be able to handle a frequency band between about 20 Hz to 20 000 kHz. The sample rate for that kind of signals should be at least 40 000 kHz to avoid aliasing. It should be noted here that the above mentioned values are just non-limiting examples. For example, in some systems the higher limit for music signals may be well below said 20 000 kHz.

The sampled digital signal is then encoded, usually on a frame by frame basis, resulting in a digital data stream with a bit rate that is determined by a codec used for encoding. The higher the bit rate, the more data is encoded, which results in a more accurate representation of the input frame. The encoded audio signal can then be decoded and passed through a digital to analogue (D/A) converter to reconstruct a signal which is as near the original signal as possible.

An ideal codec will encode the audio signal with as few bits as possible thereby optimising channel capacity, while producing decoded audio signal that sounds as close to the original audio signal as possible. In practice there is usually a trade-off between the bit rate of the codec and the quality of the decoded audio.

At present there are numerous different codecs, such as the adaptive multi-rate (AMR) codec, the adaptive multi-rate wideband (AMR-WB) codec and the extended adaptive multi-rate wideband (AMR-WB+) codec, which are developed for compressing and encoding audio signals. AMR was developed by the 3rd Generation Partnership Project (3GPP) for GSM/EDGE and WCDMA communication networks. In addition, it has also been envisaged that AMR will be used in packet switched networks. AMR is based on Algebraic Code Excited Linear Prediction (ACELP) coding. The AMR, AMR WB and AMR WB+ codecs consist of 8, 9 and 12 active bit rates respectively and also include voice activity detection (VAD) and discontinuous transmission (DTX) functionality. At the moment, the sampling rate in the AMR codec is 8 kHz and in the AMR-WB codec the sampling rate is 16 kHz. It is obvious that the codecs, codec modes and sampling rates mentioned above are just non-limiting examples.

Audio codec bandwidth extension algorithms typically apply the coding functions as well as coding parameters from the core codec. That is, the encoded audio bandwidth is split into two, out of which the lower band is processed by the core codec, and the higher band is then coded using knowledge about the coding parameters and signals from the core band (i.e. lower band). Since in most cases the low and high audio bands correlate with each other, the low band parameters can also be exploited in the high band to some extent. Using parameters from the low band coder to help the high band coding reduces the bit rate of the high band encoding significantly.

An example of split band coding algorithm is the extended AMR-WB (AMR-WB+) codec. The core encoder contains full source signal encoding algorithms while the LPC excitation signal of the high band encoder is copied from the core encoder or is locally generated random signal.

The low band coding is utilising either algebraic code excitation linear prediction (ACELP) type or transform based algorithms. The selection between the algorithms is done based on the input signal characteristics. ACELP algorithm is usually used for speech signals and for transients while music and tone like signals are usually encoded using transform coding to better handle the frequency resolution.

The high band encoding utilises linear prediction coding to model the spectral envelope of the high band signal. To save bit rate, the excitation signal is generated by up-sampling the low band excitation to the high band. That is, the low band excitation is reused at the high band by transposing it to the high band. Another method is to generate random excitation signal for the high band. The synthesised high band signal is reconstructed by filtering the scaled excitation signal through the high band LPC model.

The extended AMR-WB (AMR-WB+) codec applies a split band structure in which the audio bandwidth is divided in two parts before the encoding process. Both bands are encoded independently. However, to minimise the bit rate, the higher band is encoded using the above mentioned bandwidth extension techniques, therein part of the high band encoding is dependent on the low band encoding. In this case, the high band excitation signal for a linear prediction coding (LPC) synthesis is copied from the low band encoder. In the AMR-WB+ codec the low band range is from 0 to 6.4 kHz, while the high band is from 6.4 to 8 kHz for 16 kHz sampling frequency, and from 6.4 to 12 kHz for 24 kHz sampling frequency.

The AMR-WB+ codec is able to switch between modes also during an audio stream, provided that the sampling frequency does not change. Thus, it is possible to switch between AMR-WB modes and the extension modes employing 16 kHz sampling frequency. This functionality can be used e.g. when transmission conditions require changing from higher bit rate mode (an extension mode) to a lower bit rate mode (AMR-WB mode) to reduce congestion in the network. Similarly, if a change in network conditions allows a change from lower bit-rate mode to a higher one to enable better audio quality, AMR-WB+ can change from an AMR-WB mode to one of the extension modes. Change from a coding mode using high band extension coding to a mode using only core band coding can be accomplished simply by switching off the high band extension immediately when such mode change occurs. Similarly, when changing from a core band only mode to a mode using the high band extension, the high band is introduced immediately with full volume by switching the high band extension on. Due to bandwidth extension coding the audio bandwidth provided by the AMR-WB+ extension modes is wider than that of the AMR-WB modes, which is likely to cause annoying audible effect if the switching happens too quickly. A user might consider this change in audible audio bandwidth especially disturbing when changing from wider audio band to a narrower one, i.e. changing from an extension mode to an AMR-WB mode.

### SUMMARY OF THE INVENTION

One aim of the present invention is to provide an improved method for encoding audio signals in an encoder for reducing annoying audible effects when switching between the modes having different bandwidths. The invention is based on the idea that when the change happens from narrowband (AMR-WB mode) to wideband mode (AMR-WB+) the high band extension is not turned on immediately but the amplitude is only gradually increased to final volume to avoid too rapid change. Similarly, when switching from wideband mode to narrowband mode, the high band extension contribution is not turned off immediately but it is scaled down gradually to avoid disturbing effects.

According to the invention, such gradual introduction of the high band extension signal is realized at the parameter level by multiplying the excitation gains used for the high band synthesis with a scaling factor that is increased in small steps from zero to one within a selected time window. In e.g. AMR-WB+ codec a window length of 320 ms (4 AMR-WB+ frames of 80 ms) can be expected to provide slow enough ramp-up of the high band audio contribution. In the same way as in ramp-up of the high band audio contribution, also the gradual termination of the high band signal can be realised at parameter level, in this case by multiplying the excitation gains used for high band synthesis with a scaling factor that is decreased in small steps from one to zero during selected period of time. However, in this case we do not have updated parameters for the high band extension available once the actual switching to a core band only mode has happened. However, the high band synthesis can be performed by using the high band extension parameters received for the last frame before switching to the core only mode and the excitation signal derived from the frames received in the core only mode. A slightly modified version of this method would be to modify the LPC parameters used for the high band synthesis after the switching in such a way that the frequency response of the LPC filter is gradually forced towards more flat spectrum. This can be realised e.g. by computing a weighted average of the actually received LPC filter and a LPC filter providing a flat spectrum in ISP domain. This approach might provide improved audio quality in cases where the last frame with high band extension parameters happened to include clear spectral peak(s).

The method according to the present invention provides a similar effect as direct scaling in time domain, but performing the scaling at parameter level is computationally a more efficient solution.

The encoder according to the present invention is primarily characterised in that the encoder further comprises a scaler to control the second encoding block to gradually change the encoding properties of the encoding block in connection with a change in the operating mode of the encoder.

The device according to the present invention is primarily characterised in that the encoder further comprises a scaler to control the second encoding block to gradually change the encoding properties of the encoding block in connection with a change in the operating mode of the encoder.

The system according to the present invention is primarily characterised in that the system further comprises a scaler to control the second encoding block to gradually change the encoding properties of the second encoding block in connection with a change in the operating mode of the encoder.

The method according to the present invention is primarily characterised in that the encoding properties of the second encoding block are gradually changed in connection with a change in the operating mode.

The module according to the present invention is primarily characterised in that the module further comprises a scaler to control the second encoding block to gradually change the encoding properties of the second encoding block in connection with a change in the operating mode of the module.

The computer program product according to the present invention is primarily characterised in that the computer program product further comprises machine executable steps for gradually changing the encoding properties of the second encoding block in connection with a change in the operating mode.

The signal according to the present invention is primarily characterised in that on a mode change between said first mode and said second mode at least one of the parameters of the signal relating to said higher frequency band are gradually changed.

Compared to the prior-art approach presented above, the invention provides a solution for reducing the possible audible effects due to the switching between different bandwidth modes. Hence, the audio signal quality can be improved. The present invention provides similar functionality as direct scaling in the time domain, but performing the scaling at the parameter level is computationally more efficient solution.

### DESCRIPTION OF THE DRAWINGS

FIG. 1 presents a simplified diagram about the split band encoding decoding concept according to the present invention using two band filter banks and separate encoding and decoding blocks for each audio band,

FIG. 2 presents an example embodiment of an encoding device according to the invention,

FIG. 3 presents an example embodiment of a decoding device according to the invention,

FIG. 4a presents the spectrogram of band switching from narrowband to wideband in a prior-art encoder,

FIG. 4b presents the spectrogram of band switching from narrowband to wideband in an encoder of an embodiment of the present invention,

FIG. 4c presents the energy of encoded high band signal along time axis, when the band is switched from narrowband to wideband in a prior-art encoder and in an encoder of an embodiment of the present invention,

FIG. 5a presents the spectrogram of band switching from wideband to narrowband in a prior-art encoder,

FIG. 5b presents the spectrogram of band switching from wideband to narrowband in an encoder of an embodiment of the present invention,

FIG. 5c presents the energy of encoded high band signal along time axis, when the band is switched from wideband to narrowband in a prior-art encoder and in an encoder of an embodiment of the present invention, and

FIG. 6 shows an example of a system according to the present invention.

### DETAILED DESCRIPTION OF THE INVENTION

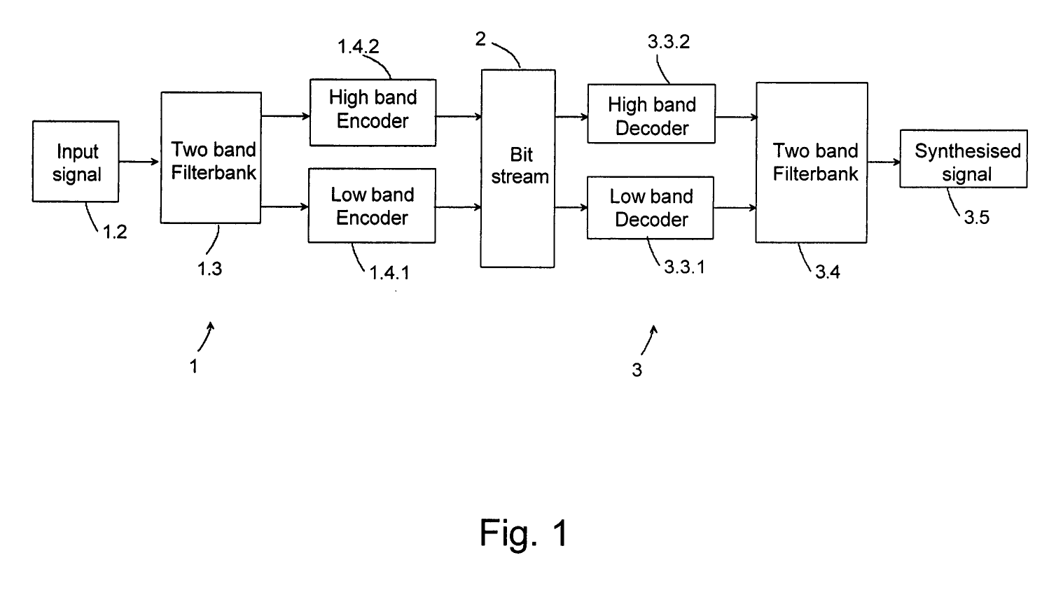

FIG. 1 presents the split band encoding and decoding concept according to an example embodiment of the present invention using two band filter banks and separate encoding and decoding blocks for each audio band. An input signal from a signal source 1.2 is first processed through an analysis filter 1.3 in which the audio band is divided into at least two audio bands, i.e. into a lower frequency audio band and a higher frequency audio band, and critically down sampled. The lower frequency audio band is then encoded in a first encoding block 1.4.1 and the higher frequency audio band is encoded in a second encoding block 1.4.2, respectively. The audio bands are encoded substantially independently on each other. The multiplexed bit stream is transmitted from the transmitting device 1 through a communication channel 2 to a receiving device 3 in which the low and high bands are decoded independently in a first decoding block 3.3.1 and in a second decoding block 3.3.2, respectively. The decoded signals are up-sampled to original sampling frequency after which a synthesis filterbank 3.4 combines the decoded audio signals to form the synthesised audio signal 3.5.

In case of AMR-WB+ operating on 16 kHz sampled audio signal the 8 kHz audio band is divided into 0-6.4 and 6.4-8 kHz bands. After the analysis filter 1.3 the critical down sampling is utilised. That is, the low band is down sampled to 12.8 kHz (=2*(0-6.4)) and the high band is resampled to 3.2 kHz (=2*(8-6.4)).

The first encoding block 1.4.1 (low band encoder) and the first decoding block 3.3.1 (low band decoder) can be, for example, the AMR-WB standard encoder and decoder while the second encoding block 1.4.2 (high band encoder) and the second decoding block 3.3.2 (high band decoder) can be implemented either as an independent coding algorithm, as a bandwidth extension algorithm or as a combination of them.

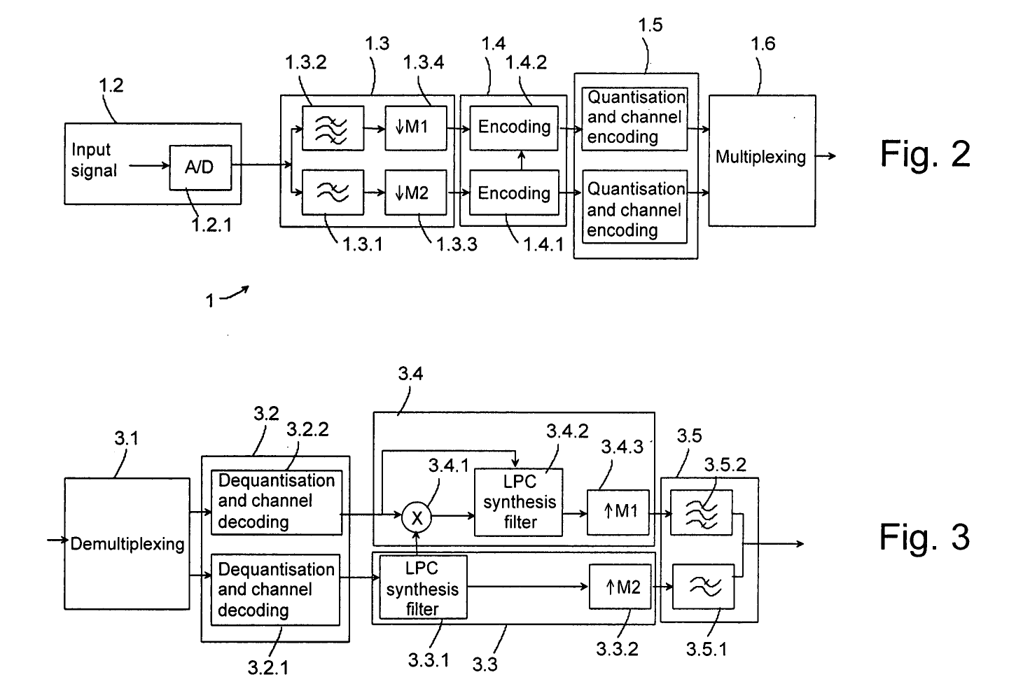

In the following an encoding device 1 according to an example embodiment of the present invention will be described in more detail with reference to FIG. 2. The encoding device 1 comprises an input block 1.2 for digitizing, filtering and framing the input signal when necessary. The digitizing of the input signal is performed by an input sampler 1.2.1 at an input sampling frequency. The input sampler frequency is in an example embodiment either 16 kHz or 24 kHz but it is obvious that other sampling frequencies can also be used. It should be noted here that the input signal may already be in a form suitable for the encoding process. For example, the input signal may have been digitised at an earlier stage and stored to a memory medium (not shown). Frames of the input signal are input to the analysis filter 1.3. The analysis filter 1.3 comprises a filter bank in which the audio band is divided into two or more audio bands. In this embodiment the filter bank comprises a first filter 1.3.1 and a second filter 1.3.2. The first filter 1.3.1 is, for example, a low pass filter having a cut-off frequency at the upper limit of the lower audio band. The cut-off frequency is e.g. about 6.4 kHz. The second filter 1.3.2 is, for example, a band pass filter having a bandwidth from the cut-off frequency of the first filter 1.3.1 up to the upper limit of the audio band. The bandwidth is e.g. 6.4 kHz-8 kHz for 16 kHz sampling frequency and 6.4 kHz-12 kHz for 24 kHz sampling frequency. It is also possible that the second filter 1.3.2 is a high pass filter, if the frequency band of the audio signal at the input of the encoder 1.4 is up-limited to less or equal than half of the sampling frequency, i.e. only frequencies below the upper limit are passed to the analysis filter 1.3. It is also possible that the audio band is divided into more than two audio bands wherein the analysis filter may comprise a filter for each audio band. However, in the following it is assumed that only two audio bands are used.

The outputs of the filter bank are critically down sampled to reduce the necessary bit rate for transmission of the audio signal. The output of the first filter 1.3.1 is down sampled in a first sampler 1.3.3 and the output of the second filter 1.3.2 is down sampled in a second sampler 1.3.4. The sampling frequency of the first sampler 1.3.3 is, for example, half the bandwidth of the first filter 1.3.1. The sampling frequency of the second sampler 1.3.4 is, for example, half the bandwidth of the second filter 1.3.2, respectively. In this example embodiment the sampling frequency of the first sampler 1.3.3 is 12.8 kHz and the sampling frequency of the second sampler 1.3.4 is 6.4 kHz for 16 kHz sampling frequency of the input audio signal and 11.2 kHz for 24 kHz sampling frequency of the input audio signal.

The samples from the first sampler 1.3.3 are input to the first encoding block 1.4.1 for encoding. The samples from the second sampler 1.3.4 are input to the second encoding block 1.4.2 for encoding, respectively. The first encoding block 1.4.1 analyses the samples to determine which excitation method is the most appropriate one for encoding the input signal. There may be two or more excitation methods to select from. For example, a first excitation method is selected for non-speech (or non-speech like) signals (e.g. music) and a second excitation method is selected for speech (or speech like) signals. The first excitation method produces, for example, a TCX excitation signal and the second excitation method produces, for example, an ACELP excitation signal.

After selecting the excitation method a LPC analysis is performed in the first encoding block 1.4.1 on the samples on a frame by frame basis to find such a parameter set which matches best with the input signal. There are some alternative methods to do this and they are known by an expert in the field wherein it is not necessary to describe the details of the LPC analysis in this application.

Information on the selected excitation method and LPC parameters are transferred to the second encoding block 1.4.2. In the second encoding block 1.4.2 uses the same excitation that was produced in the first encoding block 1.4.1. In this example embodiment, the excitation signal for the second encoding block 1.4.2 is generated by up-sampling the lower frequency audio band excitation to the higher frequency audio band. That is, the low band excitation is reused at the high band by transposing it to the higher frequency audio band. The parameters used to describe the higher frequency audio signal in AMR-WB+ codec are an LPC synthesis filter that defines the spectral characteristics of the synthesized signal, and a set of gain parameters for the excitation signal that control the amplitude of the synthesized audio.

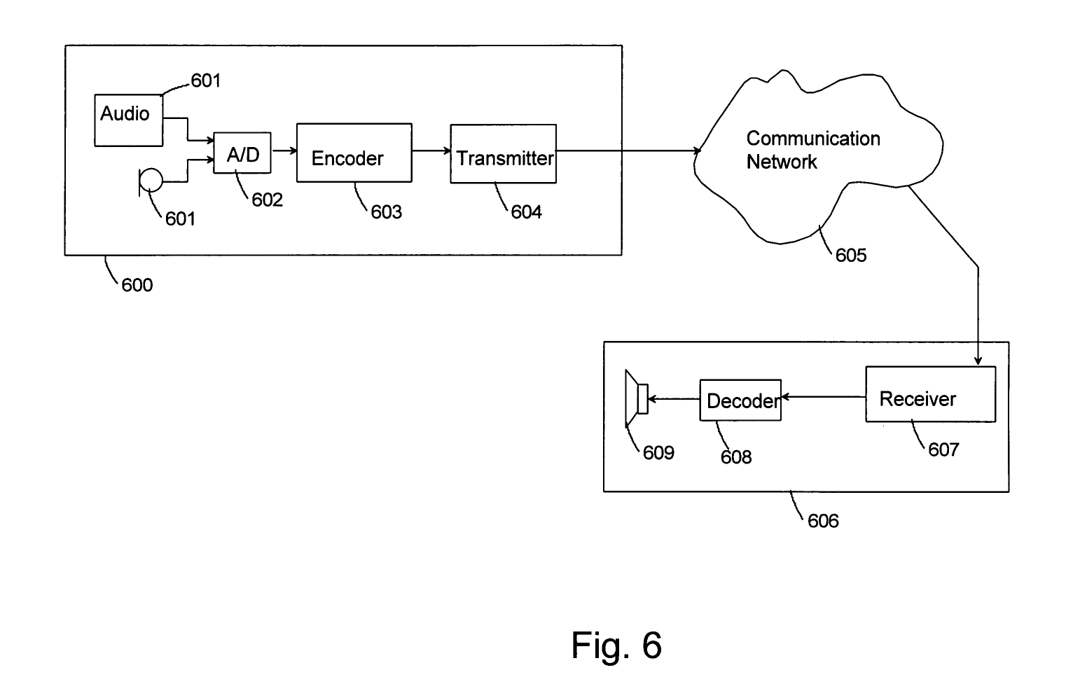

LPC parameters and excitation parameters generated by the first encoding block 1.4.1 and the second encoding block 1.4.2 are, for example, quantised and channel encoded in a quantisation and channel encoding block 1.5 and combined (multiplexed) in a same transmission stream by a stream generating block 1.6 before transmission e.g. to a transmission channel, such as a communication network 604 (FIG. 6). However, it is not necessary to transmit the parameters but they can, for example, be stored on a storage medium and at a later stage retrieved for transmission and/or decoding.

In the following, a method according to an example embodiment of the present invention will be described in more detail when a switching between a first encoding mode and a second encoding mode is performed. The first encoding mode is, for example, a narrow band encoding mode and the second encoding mode is, for example, a wide band encoding mode.

A time parameter T indicative of the length of the time the mode change lasts is defined. The time parameter T is used to change the encoding mode gradually. The value for the time parameter is, for example, 320 ms, which equals four times the frame length F (80 ms in the AMR-WB+ encoder). It is obvious that also other values for the time parameter T can be used. A multiplier M and a step value S are also defined to be used by the second encoding block during the mode change. The step value is defined so that it indicates how large steps are used at the mode change. For example, if the time parameter T equals four frames (4*FL), the step value equals 0.25 (=¼) i.e. the step value can be calculated by dividing the frame length by the time parameter (=F/T).

First, it is assumed that the encoder 1 uses the first encoding mode and a change to the second encoding mode is to be performed. The encoding of the lower frequency audio signal is continued in the first encoding block 1.4.1 as described above. A mode indicator (not shown) is set to a state indicating that the second encoding mode is selected. In addition to that, the information of the encoding mode and LPC parameters and, if necessary, other parameters from the first encoding block 1.4.1 are transferred to the second encoding block 1.4.2. In the second encoding block 1.4.2 the received LPC parameters are not taken into use as such but a modification at least to some of the parameters is performed. The multiplier M is set to zero. After that a set of LPC gain parameters are modified by multiplying the set of LPC gain parameters by the multiplier M. The modified LPC parameters are used by the second encoding block 1.4.2 in the encoding process of the current frame (set of samples). Then, for the next frame, the multiplier M is added by the step value S and the set of LPC gain parameters are modified as mentioned above. The above procedure is repeated for each successive frame until the multiplier M reaches the value 1, wherefrom the value 1 is used and the second encoding mode (the wide band mode) of operation of the encoder 1 is continued.

Next, it is assumed that the encoder 1 is using the second encoding mode and a change to the first encoding mode is to be performed. The encoding of the lower frequency audio signal is continued in the first encoding block 1.4.1 as described above. A mode indicator is set to a state indicating that the first encoding mode is selected. At this stage, the information of the encoding mode and LPC parameters are not normally transferred from the first encoding block 1.4.1 to the second encoding block 1.4.2. Therefore, for the gradual change in the encoding mode to operate, some arrangements are necessary. In a first alternative the second encoding block 1.4.2 has stored the LPC parameters used in encoding the last frame before the mode change. Then, the multiplier M is set to one and the set of LPC gain parameters are multiplied by the multiplier M and the modified set of LPC gain parameters are used in encoding the first frame after the mode change. For the following frame the value of the multiplier M is decreased by the step value S, the set of LPC parameters are multiplied by the multiplier M and the encoding is performed for that frame. The above steps (changing the multiplier value, modifying the set of LPC parameters and performing the encoding for the frame) are repeated until the multiplier reaches the value zero. After that only the first encoding block 1.4.1 continues the encoding process.

As an example, the vector used for up scaling and down scaling can be as follows. The vector contains 64 elements meaning that one element is used for a 5 ms subframe. This means that scaling up/down is done during 320 ms.
gain_hf_ramp[64]={0.01538461538462, 0.03076923076923, 0.04615384615385, 0.06153846153846, 0.07692307692308, 0.09230769230769, 0.10769230769231, 0.12307692307692, 0.13846153846154, 0.15384615384615, 0.16923076923077, 0.18461538461538, 0.20000000000000, 0.21538461538462, 0.23076923076923, 0.24615384615385, 0.26153846153846, 0.27692307692308, 0.29230769230769, 0.30769230769231, 0.32307692307692, 0.33846153846154, 0.35384615384615, 0.36923076923077, 0.38461538461538, 0.40000000000000, 0.41538461538462, 0.43076923076923, 0.44615384615385, 0.46153846153846, 0.47692307692308, 0.49230769230769, 0.50769230769231, 0.52307692307692, 0.53846153846154, 0.55384615384615, 0.56923076923077, 0.58461538461538, 0.60000000000000, 0.61538461538462, 0.63076923076923, 0.64615384615385, 0.66153846153846, 0.67692307692308, 0.69230769230769, 0.70769230769231, 0.72307692307692, 0.73846153846154, 0.75384615384615, 0.76923076923077, 0.78461538461538, 0.80000000000000, 0.81538461538462, 0.83076923076923, 0.84615384615385, 0.86153846153846, 0.87692307692308, 0.89230769230769, 0.90769230769231, 0.92307692307692, 0.93846153846154, 0.95384615384615, 0.96923076923077, 0.98461538461530}

When scaling up the higher frequency band in the second encoding block 1.4.2, the excitation gain of the second encoding block 1.4.2 is multiplied by one of the values where the index is pointing in the scaling vector. The index value is the number of 5 ms encoded subframes. Therefore after mode switching, in the first subframe (5 ms) the excitation gain of the second encoding block 1.4.2 is multiplied by the first element of the scaling vector. In the second subframe (5 ms), the excitation gain of the second encoding block 1.4.2 is multiplied by the second element of the scaling vector, etc.

When scaling down the higher frequency band in the second encoding block 1.4.2, the excitation gain of the second encoding block 1.4.2 is also multiplied by one of the values where the index is pointing in the scaling vector. The index value is the number of 5 ms encoded subframes, but the index pointer is reversed. Therefore, after mode switching, in the first subframe (5 ms) the excitation gain of the second encoding block 1.4.2 is multiplied by the last element of the scaling vector. In the second subframe (5 ms), the excitation gain of the second encoding block 1.4.2 is multiplied by the second last element of the scaling vector, etc.

When scaling down the higher frequency band (e.g. switching the mode from AMR-WB+ to AMR-WB), the last encoded speech parameters (LPC parameters, excitation and excitation gain) of the second encoding block 1.4.2 are used to generate the higher frequency band during the first 320 ms when the operation mode without the second encoding block 1.4.2 is used.

An example pseudo code can be as follows:
ExcGain2=ExcGain2*gain_hf_ramp(ind)
Exc_hf(1:n)=ExcGain2*Exc_If(1:n)
Output_hf=synth(LPC_hf, exc_hf, mem),

where

| | |
|---|---|
| ExcGain2 | = Excitation gain_in_the_second_encoding_block |
| gain_hf_ramp | = The scaling vector |
| Exc_If | = Excitation vector from the first encoding block |
| | (bandwidth 0-6.4 kHz) |
| Exc_hf | = Excitation vector from second encoding block |
| | (bandwidth 6.4-8.0 kHz) |
| Output_hf | = The synthesized signal for higher frequency band |
| Synth | = The function which builds up the synthesized signal |
| LPC | = LP filter coefficients |
| Mem | = the memory of LP filter |

A slightly modified version of this method would be to modify the LPC parameters used for the high frequency audio band synthesis after the switching in such a way that the frequency response of the LPC filter is gradually forced towards a more flat spectrum. This can be realised e.g. by computing a weighted average of the actually received LPC filter and a LPC filter providing a flat spectrum in ISP domain. This approach might provide improved audio quality in cases where the last frame with wider bandwidth extension parameters happened to include clear spectral peak(s).

The up/down scaling can also be done adaptively based on audio signal characteristics based on e.g. LPC or other parameters. Instead of linear scaling vector, the scaling vector can also be non-linear. The scaling vector can also be different for up- and down scaling.

In the following, the decoding device 3 according to the present invention will be described in more detail with reference to FIG. 3. The encoded audio signal is received from the transmission channel 2. The demultiplexer 3.1 demultiplexes the parameter information belonging to the lower frequency audio band into a first bit stream and the parameter information belonging to the higher frequency audio band into a second bit stream. The bit streams are then channel decoded and dequantised in the channel decoding and dequantisation block 3.2, when necessary.

The first channel decoded bit stream contains the LPC parameters and excitation parameters generated by the first encoding block 1.4.1 and, when the wide band mode was used, the second channel decoded bit stream contains the set of LPC gain and other LPC parameters (parameters describing the properties of the LPC filter) generated by the second encoding block 1.4.2.

The first bit stream is input to the first decoding block 3.3 which performs the LPC filtering (low band LPC synthesis filtering) according to the received LPC gain and other parameters to form the synthesised lower frequency audio band signal. After the filter 3.3.1 there is a first up-sampler 3.3.2 for sampling the decoded and filtered signal to the original sampling frequency.

The second bit stream, when present in the bit stream, is input to the second decoding block 3.4 which performs the LPC filtering (high band LPC synthesis filtering) according to the received LPC gain and other parameters to form the synthesised higher frequency audio band signal. The excitation parameters of the first bit stream are multiplied with the set of LPC gain parameters in the multiplier 3.4.1. The multiplied excitation parameters are input to the filter 3.4.2 in which also other LPC parameters of the second bit stream are input. The filter 3.4.2 reconstructs the higher frequency audio band signal on the basis of the parameters input to the filter 3.4.2. After the filter 3.4.2 there is a second up-sampler 3.4.3 for sampling the decoded and filtered signal to the original sampling frequency.

The output of the first up-sampler 3.3.2 is connected to a first filter 3.5.1 of the synthesis filter bank 3.5. Respectively, the output of the second up-sampler 3.4.3 is connected to a second filter 3.5.2 of the synthesis filter bank 3.5. The outputs of the first 3.5.1 and the second filter 3.5.2 are connected as the output of the synthesis filter bank 3.5, wherein the output signal is the reconstructed audio signal, either wide band or narrow band depending on the mode used in encoding the audio signal.

It is obvious that the encoded audio signal is not necessarily received from the communication channel 2 as in FIG. 1, but it can also be an encoded bit stream which is previously stored into a storage media.

As was described above, the present invention provides a method to turn off the high band extension contribution gradually when changing from a coding mode using high band extension coding to a mode using only core band coding. Changing the amplitude of the high band contribution step by step from full volume to zero during relatively short period of time, e.g. few hundred milliseconds will make the change in audio bandwidth smoother and less obvious for the user, providing improved audio quality. In the same way when the change occurs from a core band only mode to a mode employing the high band extension coding, the high band contribution is not introduced immediately with full volume but its amplitude is scaled from zero to full volume in small steps during relatively short time window to introduce smooth switching with improved audio quality.

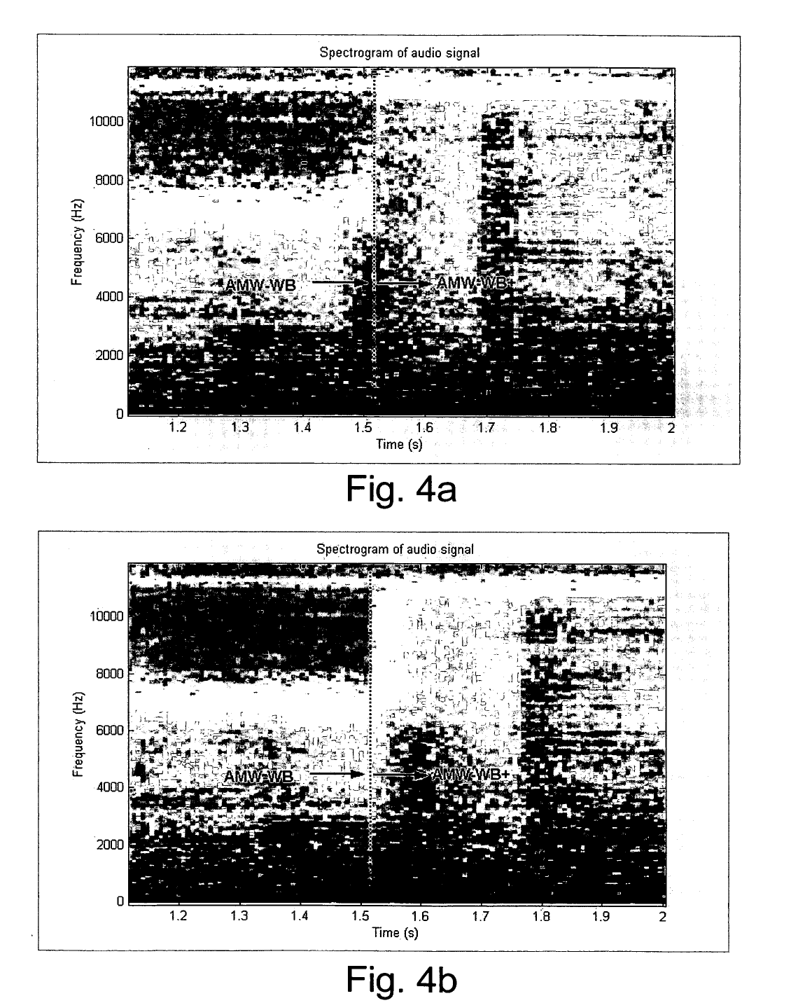

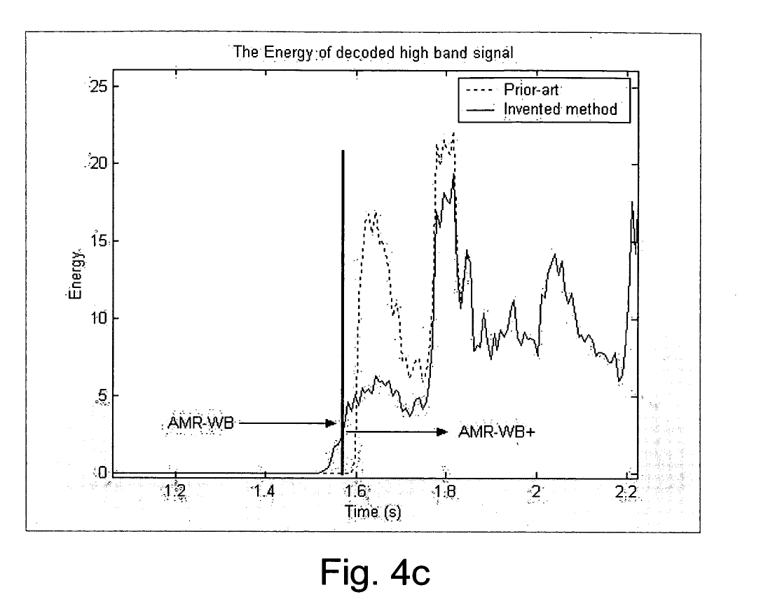

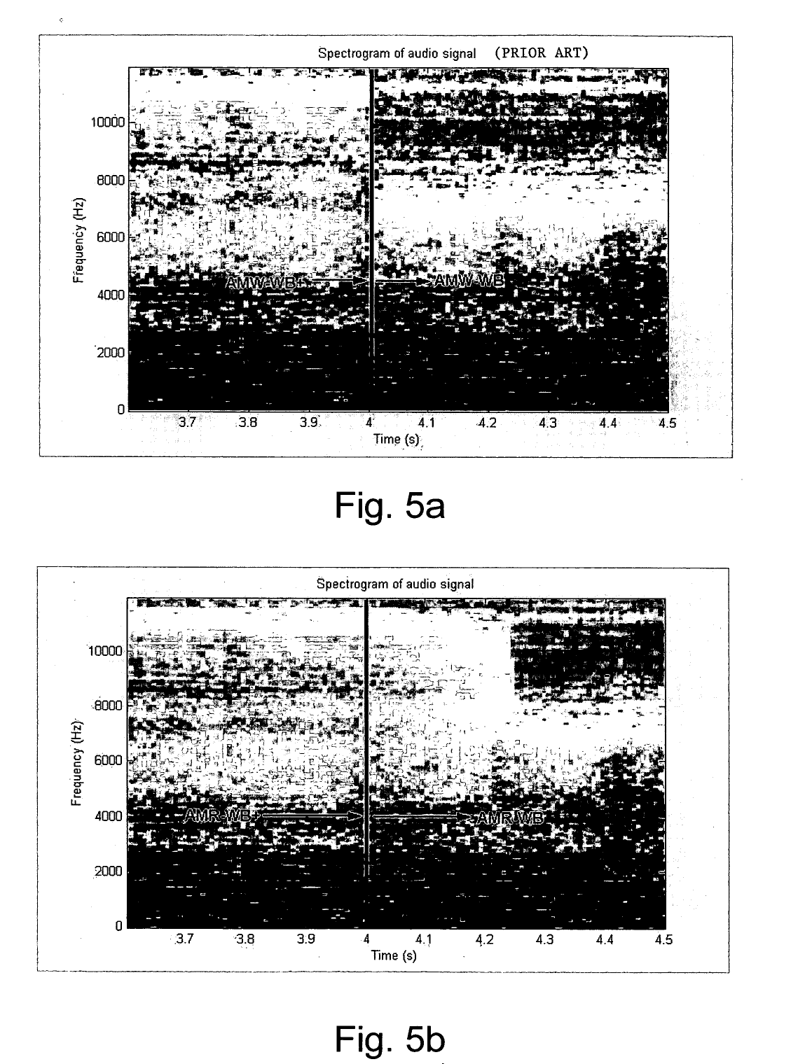

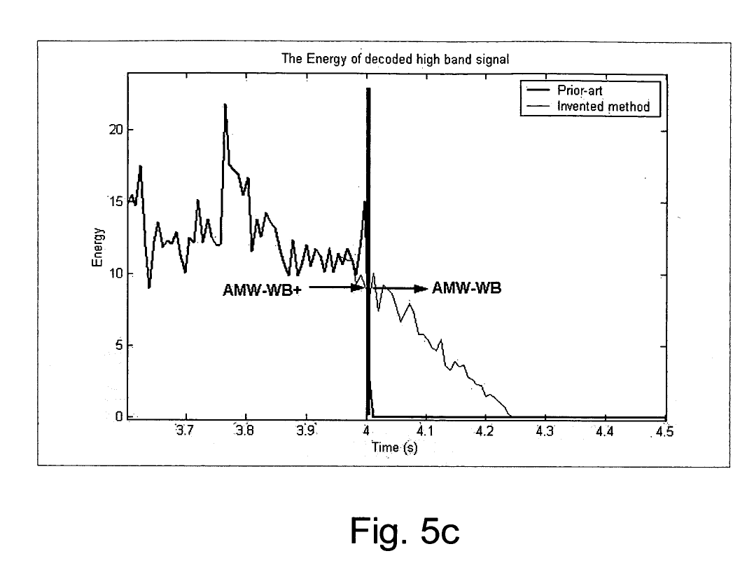

Even though the invention is mainly used for 16 kHz sampled audio, 24 kHz sampled audio signal was used for the switching examples in FIGS. 4a-5c. Therefore, AMR-WB+ operates at 24 kHz sampled audio signal. The 12 KHz audio band is divided into 0-6.4 and 6.4-12 kHz bands. The critical down sampling is utilised after the filter bank. That is, the low band is down sampled to 12.8 kHz and the high band is resampled to 11.2 kHz (=2*(12-6.4)).

FIG. 4a demonstrates the case where the prior-art switching from narrowband to wideband is performed and FIG. 4b demonstrates the case where the switching according to the present invention is performed, respectively. FIG. 4c presents the total energy of the encoded high band signal in the cases of prior-art and the switching according to the present invention.

FIG. 5a demonstrates the case where the prior-art switching from wideband to narrowband is performed and FIG. 5b demonstrates the case where the switching according to the present invention is performed, respectively. FIG. 5c presents the total energy of encoded high band signal in the cases of prior-art and the switching according to the present invention.

FIG. 6 depicts an example of a system according to the invention in which the split band encoding and decoding process can be applied. The system comprises one or more audio sources 601 producing speech and/or non-speech audio signals. The audio signals are converted into digital signals by an A/D-converter 602 when necessary. The digitised signals are input to an encoder 603 of a transmitting device 600 in which the encoding is performed according to the present invention. The encoded signals are also quantised and encoded for transmission in the encoder 603 when necessary. A transmitter 604, for example a transmitter of a mobile communications device 600, transmits the compressed and encoded signals to a communication network 605. The signals are received from the communication network 605 by a receiver 607 of a receiving device 606. The received signals are transferred from the receiver 607 to a decoder 608 for decoding, dequantisation and decompression. The decoder 608 performs the decompressing of the received bit streams to form synthesised audio signals. The synthesised audio signals can then be transformed to audio, for example, in a loudspeaker 609.

The present invention can be implemented in different kind of systems, especially in low-rate transmission for achieving more efficient compression than in prior art systems. The encoder 1 according to the present invention can be implemented in different parts of communication systems. For example, the encoder 1 can be implemented in a mobile communication device which may have limited signal processing capabilities.

The invention can be implemented at least partly as a computer program product comprising machine executable steps for performing at least some parts of the method of the invention. The encoding device 1 and decoding device 3 comprise a control block, for example a digital signal processor and/or a microprocessor, in which the computer program can be utilised.

It is obvious that the present invention is not solely limited to the above described embodiments but it can be modified within the scope of the appended claims.

1. An encoder comprising
an input for inputting frames of an audio signal in a frequency band,
a filter for dividing the frequency band into at least a lower frequency band and a higher frequency band,
a first encoding block for encoding the audio signals of the lower frequency band,
a second encoding block for encoding the audio signals of the higher frequency band,
a mode selector for selecting an operating mode for the encoder among at least a first mode and a second mode, in which first mode signals only on the lower frequency band are encoded, and in which second mode signals on both the lower and higher frequency band are encoded, and
a scaler to control the second encoding block to gradually change the encoding properties of the second encoding block in connection with a change in the operating mode of the encoder.

2. The encoder according to claim 1, wherein said encoding properties include a gain parameter, wherein said scaler comprises a calculating element to gradually change the gain parameter in connection with a change in the operating mode of the encoder.

3. The encoder according to claim 2, wherein said first encoding block is adapted to define the excitation and to deliver information relating to the excitation to said second encoding block for the encoding of signals of said higher frequency band, and that said second encoding block comprises means for associating the gain parameter to encoding of signals of said higher frequency band, wherein said calculating element is adapted to gradually change the gain parameter for use of said second encoding block .

4. The encoder according to claim 1, wherein a time parameter is defined indicative of the length of the time the mode change lasts.

5. The encoder according to claim 4, wherein the value defined for said time parameter is 320 ms.

6. The encoder according to claim 4, wherein a step value is defined indicative of how large steps are to be used at the gradual change of the encoding properties.

7. The encoder according to claim 6, wherein said step value is defined to indicate that the change of the encoding properties is gradually performed in 64 steps.

8. The encoder according to claim 6, wherein a vector is defined containing a scaling factor for the gain for each step of the change of the encoding properties.

9. The encoder according to claim 1, comprising a sampler for sampling the audio signal and forming frames of the sampled audio signal.

10. The encoder according to claim 4, wherein said time parameter is defined indicative of the number of frames the mode change lasts.

11. An AMR-WB encoder comprising
an input for inputting frames of an audio signal in a frequency band,
a filter for dividing the frequency band into at least a lower frequency band and a higher frequency band,
a first encoding block for encoding the audio signals of the lower frequency band,
a second encoding block (for encoding the audio signals of the higher frequency band,
a mode selector for selecting an operating mode for the encoder among at least a first mode and a second mode, in which first mode signals only on the lower frequency band are encoded, and in which second mode signals on both the lower and higher frequency band are encoded, and
a scaler to control the second encoding block to gradually change the encoding properties of the second encoding block in connection with a change in the operating mode of the encoder.

12. The AMR-WB encoder according to claim 11, wherein the gradually changed encoding properties of the encoding block include excitation, LPC and gain parameters.

13. A device comprising an encoder comprising
an input for inputting frames of an audio signal in a frequency band,
an analysis filter for dividing the frequency band into at least a lower frequency band and a higher frequency band,
a first encoding block for encoding the audio signals of the lower frequency band,
a second encoding block for encoding the audio signals of the higher frequency band, and
a mode selector for selecting an operating mode for the encoder among at least a first mode and a second mode, in which first mode signals only on the lower frequency band are encoded, and in which second mode signals on both the lower and higher frequency band are encoded,
wherein the encoder further comprises a scaler to control the second encoding block to gradually change the encoding properties of the encoding block in connection with a change in the operating mode of the encoder.

14. The device according to claim 13, wherein said encoding properties include a gain parameter, wherein said scaler comprises a calculating element to gradually change the gain parameter in connection with a change in the operating mode of the encoder.

15. A system comprising an encoder comprising
an input for inputting frames of an audio signal in a frequency band,
a filter for dividing the frequency band into at least a lower frequency band and a higher frequency band,
a first encoding block for encoding the audio signals of the lower frequency band,
a second encoding block for encoding the audio signals of the higher frequency band, and
a mode selector for selecting an operating mode for the encoder among at least a first mode and a second mode, in which first mode signals only on the lower frequency band are encoded, and in which second mode signals on both the lower and higher frequency band are encoded,
wherein the system further comprises a scaler to control the second encoding block to gradually change the encoding properties of the second encoding block in connection with a change in the operating mode of the encoder.

16. The system according to claim 15, wherein said encoding properties include a gain parameter, wherein said scaler comprises a calculating element to gradually change the gain parameter in connection with a change in the operating mode of the encoder.

17. A method for compressing audio signals in a frequency band, the method comprising
dividing the frequency band into at least a lower frequency band and a higher frequency band,
encoding the audio signals of the lower frequency band by a first encoding block,
encoding the audio signals of the higher frequency band by a second encoding block,
selecting an operating mode for the encoding among at least a first mode and a second mode, in which first mode signals only on the lower frequency band are encoded, and in which second mode signals on both the lower and higher frequency band are encoded, and
gradually changing encoding properties of the second encoding block in connection with a change in the operating mode.

18. The method according to claim 17, comprising using a gain parameter as one of said encoding properties , and gradually changing the gain parameter in connection with a change in the operating mode.

19. The method according to claim 18, comprising
defining said gain parameter in said first encoding block for controlling the encoding of signals on said lower frequency band,
delivering said gain parameter to said second encoding block, and
gradually changing the gain parameter for use of said second encoding block .

20. The method according to claim 17, comprising defining a time parameter indicative of the length of the time the mode change lasts.

21. The method according to claim 20, comprising defining a step value indicative of how large steps are to be used at the gradual change of the encoding properties.

22. The method according to claim 17, comprising
sampling the audio signal, and
forming frames from the sampled audio signal.

23. The method according to claim 22, comprising defining a parameter indicative of the number of frames the mode change lasts.

24. The method according to claim 17, comprising
using LPC excitation in the encoding producing a set of LPC parameters, and
gradually changing at least one of the LPC parameters.

25. A module for encoding frames of an audio signal in a frequency band which is divided into at least a lower frequency band and a higher frequency band, the module comprising
a first encoding block for encoding the audio signals of the lower frequency band,
a second encoding block for encoding the audio signals of the higher frequency band,
a mode selector for selecting an operating mode for the module among at least a first mode and a second mode, in which first mode signals only on the lower frequency band are encoded, and in which second mode signals on both the lower and higher frequency band are encoded, and
a scaler to control the second encoding block to gradually change the encoding properties of the second encoding block in connection with a change in the operating mode of the module.

26. The module according to claim 25, wherein said encoding properties include a gain parameter, wherein said scaler comprises a calculating element to gradually change the gain parameter in connection with a change in the operating mode of the encoder.

27. A computer program product comprising machine executable steps stored in a readable medium for execution on a processor, the machine executable steps when executed for
compressing audio signals in a frequency band divided into at least a lower frequency band and a higher frequency band,
encoding the audio signals of the lower frequency band by a first encoding block,
encoding the audio signals of the higher frequency band by a second encoding block,
selecting an operating mode for the encoding among at least a first mode and a second mode, in which first mode signals only on the lower frequency band are encoded, and in which second mode signals on both the lower and higher frequency band are encoded, and
gradually changing the encoding properties of the second encoding block in connection with a change in the operating mode.

28. The computer program product according to claim 27, wherein said encoding properties include a gain parameter, wherein said computer program product comprises machine executable steps for gradually changing the gain parameter in connection with a change in the operating mode of the encoder.

29. A signal comprising a bit stream including parameters for a decoder to decode said bit stream, the bit stream being encoded from frames of an audio signal in a frequency band, which is divided into at least a lower frequency band and a higher frequency band, and at least a first mode and a second mode are defined for the signal, in which first mode signals only on the lower frequency band are encoded, and in which second mode signals on both the lower and higher frequency band are encoded, wherein on a mode change between said first mode and said second mode at least one of the parameters of the signal relating to said higher frequency band are gradually changed.

30. The signal according to claim 29, wherein said encoding properties include a gain parameter, wherein said signal comprises said gain parameter which gradually changes in connection with a change in the operating mode of the encoder.
